(19) United States
(12) Patent Application Publication
(10) Pub. No.: US 2017/0218199 A1
(43) Pub. Date: Aug. 3, 2017

(54) POLYMERIC MATERIALS

(71) Applicant: VICTREX MANUFACTURING LIMITED, Lancashire (GB)

(72) Inventors: Adam CHAPLIN, Lancashire (GB); Carlo CAPRA, Griesheim (DE)

(73) Assignee: VICTREX MANUFACTURING LIMITED, Lancashire (DE)

(21) Appl. No.: 15/329,787

(22) PCT Filed: Jul. 29, 2015
(86) PCT No.: PCT/GB2015/052187

§ 371 Date: Jan. 27, 2017

(30) Foreign Application Priority Data
Jul. 30, 2014 (GB) 1413489.4

(51) Int. Cl. C08L 71/00; C08G 65/40

(52) U.S. Cl. CPC C08L 71/00; C08G 65/4025; C08L 2205/025; C08G 2650/40; C08L 2205/06

(57) ABSTRACT

A blend comprising:
(i) a polymeric material (A) having a repeat unit of formula

—O—Ph—O—Ph—CO—Ph— I

and a repeat unit of formula

—O—Ph—Ph—O—Ph—CO—Ph— II

wherein Ph represents a phenylene moiety; and
(ii) a polymeric material (B) having a repeat unit of formula (XX)

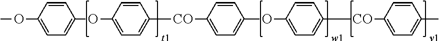

wherein t1 and w1 independently represent 0 or 1 and v1 represents 0, 1 or 2.

This invention relates to polymeric materials and particularly, although not exclusively, relates to blends comprising a polyaryletherketone, for example polyetheretherketone (PEEK).

PEEK is a very well-known high performance thermoplastic polymer. It has excellent mechanical and chemical resistance properties. For example, it has high fracture toughness and a high level of crystallinity. However, for some applications, it is desirable to provide a material which has improved fracture toughness while still maintaining a high level of crystallinity. It is an object of the present invention to address this problem.

According to a first aspect of the invention, there is provided a blend comprising:

(i) a polymeric material (A) having a repeat unit of formula

—O—Ph—O—Ph—CO—Ph— I

and a repeat unit of formula

—O—Ph—Ph—O—Ph—CO—Ph— II

wherein Ph represents a phenylene moiety; and

(ii) a polymeric material (B) having a repeat unit of formula (XX)

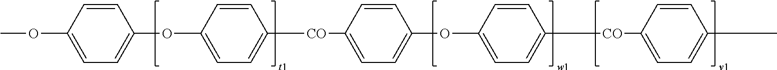

wherein t1 and w1 independently represent 0 or 1 and v1 represents 0, 1 or 2.

Advantageously, the blend is found to exhibit high fracture toughness in combination with high crystallinity. Furthermore, advantageously, the melting temperature (Tm) is less than that of polymeric material (B); the glass transition temperature (Tg) is higher than for polymeric material (B) and the crystallisation temperature (Tc) is lower than for polymeric material (B).

Said polymeric material (A) is preferably semi-crystalline. A skilled person can readily assess whether a polymer is semi-crystalline, for example, by wide angle X-ray diffraction (also referred to as Wide Angle X-ray Scattering or WAXS) or by Differential Scanning calorimetry (DSC).

In polymeric material (A), said repeat units I and II are preferably in the relative molar proportions 1:11 of from 50:50 to 95:5, more preferably of from 60:40 to 95:5, most preferably of from 65:35 to 95:5, e.g. 75:25.

Preferably, in said polymeric material (A), the following relationship applies:

log₁₀ (X%)>1.50−0.26 MV;

wherein X% refers to the % crystallinity measured as described in Example 4 and MV refers to the melt viscosity measured as described in Example 3 at 340° C.

The phenylene moieties (Ph) in each repeat unit I and II may independently have 1,4-para linkages to atoms to which they are bonded or 1,3-meta linkages. Where a phenylene moiety includes 1,3-linkages, the moiety will be in the amorphous phase of the polymer. Crystalline phases will include phenylene moieties with 1,4-linkages. In many applications it is preferred for the polymeric material (C) to be highly crystalline and, accordingly, the polymeric material (C) preferably includes high levels of phenylene moieties with 1,4-linkages.

In a preferred embodiment, at least 95%, preferably at least 99%, of the number of phenylene moieties (Ph) in the repeat unit of formula I have 1,4-linkages to moieties to which they are bonded. It is especially preferred that each phenylene moiety in the repeat unit of formula I has 1,4-linkages to moieties to which it is bonded.

In a preferred embodiment, at least 95%, preferably at least 99%, of the number of phenylene moieties (Ph) in the repeat unit of formula II have 1,4-linkages to moieties to which they are bonded. It is especially preferred that each phenylene moiety in the repeat unit of formula II has 1,4-linkages to moieties to which it is bonded.

Preferably, the phenylene moieties in repeat unit of formula I are unsubstituted. Preferably, the phenylene moieties in repeat unit of formula II are unsubstituted.

Said repeat unit of formula I suitably has the structure

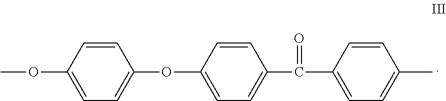

Said repeat unit of formula II suitably has the structure

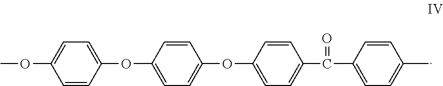

Said polymeric material (A) may include at least 50 mol %, preferably at least 60 mol %, of repeat units of formula III. Particular advantageous polymers may include at least 62 mol %, or, especially, at least 64 mol % of repeat units of formula III. Said polymeric material (A) may include less than 90 mol %, suitably 82 mol % or less of repeat units of formula III. Said polymeric material (A) may include 58 to 82 mol %, preferably 60 to 80 mol %, more preferably 62 to 77 mol % of units of formula III.

Said polymeric material (A) may include at least 10 mol %, preferably at least 18 mol %, of repeat units of formula IV. Said polymeric material (A) may include less than 42 mol %, preferably less than 39 mol % of repeat units of formula IV. Particularly advantageous polymers may include 38 mol % or less; or 36 mol % or less of repeat units of formula IV. Said polymeric material (A) may include 18 to 42 mol %, preferably 20 to 40 mol %, more preferably 23 to 38 mol % of units of formula IV.

The sum of the mol % of units of formula III and IV in said polymeric material (A) is suitably at least 95 mol %, is preferably at least 98 mol %, is more preferably at least 99 mol % and, especially, is about 100mol %.

The ratio defined as the mol % of units of formula III divided by the mol % of units of formula IV may be in the range 1.8 to 5.6, is suitably in the range 2.3 to 4 and is preferably in the range 2.6 to 3.3.

The Tm of said polymeric material (A) may be less than 330° C., is suitably less than 320° C., is preferably less than 310° C. In some embodiments, the Tm may be less than 306° C. The Tm may be greater than 280° C., or greater than 290° C., 295° C. or 300° C. The Tm is preferably in the range 300° C. to 310° C.

In a preferred embodiment, said polymeric material (A) has a Tg in the range 145° C.-155° C., a Tm in the range 300° C. to 310° C. and the difference between the Tm and Tg is in the range 145° C. to 165° C.

Said polymeric material (A) may have a crystallinity measured as described in Example 4 of at least 5%, preferably at least 10%, more preferably at least 15%, even more preferably at least 20%, even more preferably at least 23%. The crystallinity measured by WAXS (as described by Blundell and Osborn, supra) may also be at least 23%.

Said polymeric material (A) suitably has a melt viscosity (MV) (measured as described in Example 3 at 400° C.) of at least 0.06 kNsm⁻², preferably has a MV of at least 0.09 kNsm⁻², more preferably at least 0.12 kNsm⁻², especially at least 0.15 kNsm⁻².

The level of crystallinity in said polymeric material (B) (measured as described in Example 4 or by WAXS as described) may be at least 15%, suitably at least 20%, preferably at least 25% and, more preferably, at least 30%. In especially preferred embodiments, the crystallinity may be greater than 30%, more preferably greater than 35%. The level of crystallinity may be less than 60%.

Said polymeric material (B) may have a repeat unit selected from a repeat unit XX wherein t1=1, v1=0 and w1=0; t1=0, v1=0 and w1=0; t1=0, w1=1, v1=2; or t1=0, v1=1 and w1=0. Polymeric material (B) more preferably has a repeat unit wherein t1=1, v1=0 and w1-0; or t1=0, v1=0 and w1=0. Polymeric material (B) more preferably has a repeat unit wherein t1=1, v1=0 and w1=0.

Polymeric material (B) suitably includes at least 50 mol %, (e.g. 50-100 mol %), preferably at least 60 mol % (e.g. 60-100 mol %), more preferably at least 80 mol % (e.g. 80 to 100 mol %), of repeat units of formula XX, especially such units where t1=1, v1=0 and w1=0.

Polymeric material (B) suitably includes at least 50 wt % (e.g. 50-100 wt %) of repeat units of formula XX.

Polymeric material (B) preferably consists essentially of a repeat unit of a formula XX, especially such a repeat unit wherein t1=1, v1=0 and w1=0.

In preferred embodiments, said polymeric material (B) is selected from polyetheretherketone, polyetherketone, polyetherketoneetherketoneketone and polyetherketoneketone. In a more preferred embodiment, said polymeric material (B) is selected from polyetherketone and polyetheretherketone. In an especially preferred embodiment, said polymeric material (B) is polyetheretherketone.

Said polymeric material (B) preferably has a melt viscosity (MV) measured as described in Example 3 at 400° C. of at least 0.06 kNsm⁻², preferably has a MV of at least 0.08 kNsm⁻², more preferably at least 0.085 kNsm⁻², especially at least 0.09 kNsm⁻². Said polymeric material (B) may have a MV of less than 1.00 kNsm⁻², suitably less than 0.8 kNsm⁻².

The difference between the MV of polymeric material (A) and polymeric material (B) (both being measured as described in Example 3 at 400° C.) is preferably less than 0.3 kNsm⁻², more preferably less than 0.15 kNsm⁻².

The blend comprising polymeric material (A) and polymeric material (B) may have a crystallinity measured by one or both of the Example 4 method or WAXS as described of at least 30% or at least 33%.

The polymeric material (A) and the polymeric material (B) suitably define a combination (which is preferably a substantially homogenous mixture) which exhibits a single Tm and/or a single Tg.

In the blend, the difference between the Tm and Tg may be in the range 155° C. to 185° C.

In the blend, the Tm is preferably less than 335° C. It may be in the range 310° C. to 335° C.

In the blend, the Tg is preferably greater than 148° C. It may be in the range 149° C. to 158° C.

Said blend may be part of a composition which may include said blend and a filler. Said filler may include a fibrous filler or a non-fibrous filler. Said filler may include both a fibrous filler and a non-fibrous filler. A said fibrous filler may be continuous or discontinuous.

A said fibrous filler may be selected from inorganic fibrous materials, non-melting and high-melting organic fibrous materials, such as aramid fibres, and carbon fibre.

A said fibrous filler may be selected from glass fibre, carbon fibre, asbestos fibre, silica fibre, alumina fibre, zirconia fibre, boron nitride fibre, silicon nitride fibre, boron fibre, fluorocarbon resin fibre and potassium titanate fibre. Preferred fibrous fillers are glass fibre and carbon fibre.

A fibrous filler may comprise nanofibres.

A said non-fibrous filler may be selected from mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and barium sulfate. The non-fibrous fillers may be introduced in the form of powder or flaky particles.

Preferably, said filler comprises one or more fillers selected from glass fibre, carbon fibre, aramid fibres, carbon black and a fluorocarbon resin. More preferably, said filler comprises glass fibre or carbon fibre. Such filler preferably comprises glass fibre.

A composition as described may include 50 to 90 wt % (e.g. 60 to 80 wt %) of said blend and 10 to 50 wt % (e.g. 20 to 40 wt %) of filler. Preferred embodiments include greater than 20 wt %, more preferably greater than 30 wt % of filler.

Said blend referred to preferably consists essentially of thermoplastic polymers, for example polymeric material (A) and polymeric material (B) and optional further thermoplastic polymer(s).

Said blend may include a polymeric material (C) having a repeat unit of formula

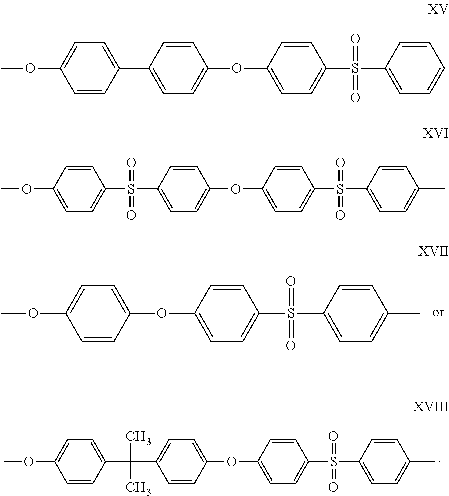

Said polymeric material (C) may include at least 75 mol %, preferably at least 90 mol %, more preferably at least 99 mol %, especially at least 100 mol % of repeat units of formula XV, XVI, XVII or XVIII.

Said polymeric material (C) may include at least 75 mol %, preferably at least 90 mol %, more preferably at least 99 mol %, especially at least 100 mol % of repeat units of formula XV, XVI, XVII or XVIII.

Said polymeric material (C) may be a homopolymer or a copolymer, for example a random or block copolymer. When polymeric material (C) is a copolymer, it may include more than one repeat unit selected from XV, XVI, XVII and XVIII.

In a preferred embodiment, polymeric material (C) includes said repeat unit of formula XV.

Said polymeric material (C) may have a melt flow rate (MFR) equal to or higher than 5 g/10 min at 365° C. and under a load of 5.0 kg, preferably equal to or higher than 10 g/10 min at 365° C. and under a load of 5.0 kg, more preferably equal to or higher than 14 g/10 min at 365° C. and under a load of 5.0 kg, as measured in accordance with ASTM method D1238; to measure said melt flow rate, a Tinius Olsen Extrusion Plastometer melt flow test apparatus can be used.

Said blend may include 0 to 40 wt % of said polymeric material (C).

In one preferred embodiment, there is provided a blend comprising thermoplastic polymers in the absence of filler. Pellets or granules may be provided comprising said blend. Said pellets or granules suitably comprise at least 90 wt %, at least 95 wt % or at least 99 wt % of thermoplastic polymers, for example said polymeric material (A), said polymeric material (B) and, optionally, said polymeric material (C). Said pellets or granules may comprise 25 to 80 wt % of polymeric material (A), 20 to 75 wt % of polymeric material (B) and 0 to 40 wt % of polymeric material (C). In one embodiment, said pellets or granules may comprise 30 to 40 wt % of polymeric material (A), 30 to 40 wt % of polymeric material (B) and 20 to 40 wt % of polymeric material (C). In another embodiment, said pellets or granules may include 50 to 80 wt % of polymeric material (A) and 20 to 50 wt % of polymeric material (B).

Pellets or granules may have a maximum dimension of less than 10 mm, preferably less than 7.5 mm, more preferably less than 5.0 mm.

According to a second aspect of the invention there is provided a method of improving the fracture toughness of a polymeric material (B) having a repeat unit of formula (XX)

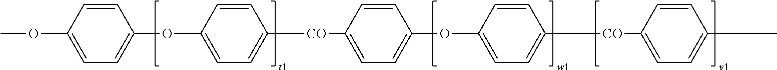

wherein t1 and w1 independently represent 0 or 1 and v1 represents 0, 1 or 2, the method comprising:

(a) selecting polymeric material (B);

(b) selecting a polymeric (A) having a repeat unit of formula

—O—Ph—O—Ph—CO—Ph— I

and a repeat unit of formula

—O—Ph—Ph—O—Ph—CO—Ph— II

wherein Ph represents a phenylene moiety; and

(c) blending polymeric material (A) with polymeric material (B).

The method preferably comprises melt processing, for example using an extruder, said polymeric material (A) and said polymeric material (B). Step (c) of the method is preferably undertaken at a temperature above the melting temperature Tm of polymeric material (A) and polymeric material (B).

Said polymeric material (A) preferably has a crystallinity of at least 5%, preferably at least 10%, more preferably at least 15%, even more preferably at least 20%, even more preferably at least 23%, even more preferably at least 27%, most preferably at least 30% or is crystallisable to have a crystallinity of at least 5%, preferably at least 10%, more preferably at least 15%, even more preferably at least 20%, even more preferably at least 23%, even more preferably at least 27%, most preferably at least 30%.

Said polymeric material (B) preferably has a crystallinity of at least 30%, preferably at least 35% or is crystallisable to have a crystallinity of at least 30%, preferably at least 35%.

After step (c), the blend may have a crystallinity of at least 30%, preferably at least 33% or is crystallisable to have a crystallinity of at least 30%, preferably at least 33%.

Crystallinity may be assessed by WARS as described above.

Said polymeric material (A) and said polymeric material (B) may be as described according to the first aspect.

Said method may include selecting a polymeric material (C) as described according to the first aspect and contacting (and suitably melt-processing) it with polymeric material (A) and polymeric material (B) to prepare a blend comprising polymeric material (A), polymeric material (B) and polymeric material (C).

Said blend prepared may have any feature of the blend of the first aspect.

The method may include a step which comprises forming pellets after step (c), said pellets comprising polymeric material (A), polymeric material (B) and, optionally, polymeric material (C). The pellets may have any feature of the pellets of the first aspect.

According to a third aspect of the invention, there is provided a method of making a composition which comprises:

(i) selecting a filler;

(ii) contacting the filler with a blend as described according to the first and second aspects.

The composition of the third aspect may have any feature of the composition described in the first aspect.

In a fourth aspect, there is provided the use of a polymeric material (A) as described according to the first and/or second aspects for improving the fracture toughness of a polymeric material (B) as described according to the first and/or second aspects.

According to a fifth aspect of the invention, there is provided a pack comprising a blend as described herein.

Said pack may include at least 1 kg, suitably at least 5 kg, preferably at least 10 kg, more preferably at least 14 kg of material of which at least a part is made up of said blend. Said pack may include 1000 kg or less, preferably 500 kg or less of said material. Preferred packs include 10 to 500 kg of said material.

Said pack may include at least 1 kg, suitably at least 5 kg, preferably at least 10 kg, more preferably at least 14 kg of a said blend. Said pack may include 1000 kg or less, preferably 500 kg or less of said blend. Preferred packs include 10 to 500 kg of a said blend.

Said blend in said pack may be in powder or granular form.

Said pack may comprise packaging material (which is intended to be discarded or re-used) and a desired material (which suitably comprises said blend). Said packaging material preferably substantially fully encloses said desired material. Said packaging material may comprise a first receptacle, for example a flexible receptacle such as a plastics bag in which said desired material is arranged. The first receptacle may be contained within a second receptacle for example in a box such as a cardboard box.

In a sixth aspect, there is provided a component which comprises, preferably consists essentially of, a blend or composition according to the first aspect. Said component may be an injection moulded component or an extruded component. It may be a pipe. Said component preferably includes at least 10 g (e.g. at least 100 g or at least 1 kg) of said polymeric material (A) and at least 10 g (e.g. at least 100 g or at least 1 kg) of said polymeric material (B).

When said component is a pipe, said pipe may have a wall thickness of at least 0.8 mm. Preferably said component is thick-walled pipe. In this case, said pipe may be have a wall thickness (preferably along at least 1 m of the length of the pipe) of at least 5 mm, especially at least 10 mm. The wall thickness may be in the range of 5 to 30 mm. The pipe may have a length of at least 5 m, preferably at least 10 m.

Any aspect of any invention described herein may be combined with any feature of any other invention or embodiment described herein mutatis mutandis.

Specific embodiments of the invention will now be described by way of example.

The following materials are referred to hereinafter:

VICTREX 650G—refers to a polyetheretherketone available from Victrex, UK. The polymer has an MV of 0.65 KNsm⁻² when measured as described in Example 3 at 400° C.

VICTREX 150G—refers to a polyetheretherketone available from Victrex, UK. The polymer has an MV of 0.15 KNsm⁻² when measured as described in Example 3 at 400° C.

PPSU—refers to Ultrason P3010 obtained from BASF having MFR 20 g/10 min@360° C./10 kg.

### EXAMPLE 1

### Preparation of 0.5 mol polyetheretherketone (PEEK)—polyetherdiphenyletherketone (PEDEK) copolymer

A 0.5 litre flanged flask fitted with a ground glass lid, stirrer/stirrer guide, nitrogen inlet and outlet was charged with 4,4′-diflurobenzophenone (111.29 g, 0.510 mol), 1,4-dihydroxybenzene (41.30 g, 0.375 mol), 4,4′-dihydroxydiphenyl (23.28 g, 0.125 mol) and diphenylsulphone (241.07 g) and purged with nitrogen for 1 hour. The contents were then heated under a nitrogen blanket to 160° C. to form an almost colourless solution. While maintaining a nitrogen blanket, dried sodium carbonate (53.00 g, 0.5 mole) and potassium carbonate (2.76 g, 0.02 mol), both sieved through a screen with a mesh size of 500 micrometres, were added. The temperature was raised to 185° C. at 1° C./min and held for 100 minutes. The temperature was raised to 205° C. at 1° C./min and held for 20 minutes. The temperature was raised to 315° C. at 1° C./min and held at this temperature until the desired MV was reached as indicated by the torque rise on the stirrer. The required torque rise was determined from a calibration graph of torque rise versus MV. The reaction mixture was then poured into a foil tray, allowed to cool, milled and washed with 2 litres of acetone and then with warm water at a temperature of 40-50° C. until the conductivity of the waste water was <2 μS. The resulting polymer powder was dried in an air oven for 12 hours at 120° C. The MV of the resulting polymer was 0.60 kNsm⁻² measured according to example 3 at 400° C. and the crystallinity was 21% measured according to Example 4.

### EXAMPLE 2

### Preparation of polyetheretherketone (PEEK)—polyetherdiphenyletherketone (PEDEK) copolymer

A 300 litre vessel fitted with a lid, stirrer/stirrer guide, nitrogen inlet and outlet was charged with diphenylsulphone (125.52 kg) and heated to 150° C. Once fully melted 4,4′-diflurobenzophenone (44.82 kg, 205.4 mol), 1,4-dihydroxybenzene (16.518 kg, 150 mol) and 4,4′-dihydroxydiphenyl (9.311 kg, 50 mol) were charged to the vessel. The contents were then heated to 160° C. While maintaining a nitrogen blanket, dried sodium carbonate (21.368 kg, 201.6 mol) and potassium carbonate (1.106 kg, 8 mol), both sieved through a screen with a mesh of 500 micrometres, were added. The D50 of the sodium carbonate was 98.7 μm. The temperature was raised to 180° C. at 1° C./min and held for 100 minutes. The temperature was raised to 200° C. at 1° C./min and held for 20 minutes. The temperature was raised to 305° C. at 1° C./min and held until desired melt viscosity was reached, as determined by the torque rise of the stirrer. The required torque rise was determined from a calibration graph of torque rise versus MV. The reaction mixture was poured via a band caster into a water bath, allowed to cool, milled and washed with acetone and water. The resulting polymer powder was dried in a tumble dryer until the contents temperature measured 112° C. The MV of the resulting polymer was 0.15 kNsm⁻² measured according to Example 3 at 400° C. and the crystallinity was 29% measured according to Example 4.

### EXAMPLE 3

### Determination of Melt Viscosity (MV) of Polymer

Unless otherwise stated, this was measured using capillary rheometry operating at 340° C. or 400° C. (as specified) at a shear rate of 1000 s⁻¹ using a circular cross-section tungsten carbide die, 0.5 mm (capillary diameter×3.175 mm (capillary length). The MV measurement was taken 5 minutes after the polymer had fully melted, which is taken to be 5 minutes after the polymer is loaded into the barrel of the rheometer.

### EXAMPLE 4

### Differential Scanning Calorimetry of Polyaryletherketones of Examples

Crystallinity described herein may be assessed by several methods for example by density, by IR spectroscopy, by x ray diffraction or by differential scanning calorimetry (DSC). The DSC method has been used to evaluate the crystallinity that developed in the polymers from Examples 1 and 2 using a Mettler Toledo DSC1 Star system with FRS5 sensor.

The Glass Transition Temperature (Tg), the Melting Temperature (Tm) and Heat of Fusions of Melting (AHm) for the polymers were determined using the following DSC method.

A dried sample of each polymer was compression moulded into an amorphous film, by heating 7 g of polymer in a mould at 400° C. under a pressure of 50 bar for 2 minutes, then quenching in cold water producing a film of dimensions 120×120 mm, with a thickness in the region of 0.20 mm. An 8 mg plus or minus 3 mg sample of each film was scanned by DSC as follows:
Step 1 Perform and record a preliminary thermal cycle by heating the sample from 30° C. to 400° C. at 20° C./min.
Step 2 Hold for 5 minutes.
Step 3 Cool at 20° C./min to 30° C. and hold for 5 mins.
Step 4 Re-heat from 30° C. to 400° C. at 20° C./min, recording the Tg, Tn, Tm, ΔHn and ΔHm.

Tc is measured on the cooling cycle (Step 3) and is the temperature at which the crystallisation exotherm reaches a minimum.

From the DSC trace resulting from the scan in step 4, the onset of the Tg was obtained as the intersection of the lines drawn along the pre-transition baseline and a line drawn along the greatest slope obtained during the transition. The Tn was the temperature at which the main peak of the cold crystallisation exotherm reaches a maximum. The Tm was the temperature at which the main peak of the melting endotherm reached a maximum.

The Heat of Fusion for melting (AHm) was obtained by connecting the two points at which the melting endotherm deviates from the relatively straight baseline. The integrated area under the endotherm as a function of time yields the enthalpy (mJ) of the melting transition: the mass normalised heat of fusion is calculated by dividing the enthalpy by the mass of the specimen (J/g). The level of crystallisation (X(%)) is determined by dividing the Heat of Fusion of the specimen by the Heat of Fusion of a totally crystalline polymer, which for polyetheretherketone and for the PEEK-PEDEK copolymer is 130 J/g and for the PPSU containing blend of Example 15 is 91 J/g. Note that PPSU is amorphous and does not contribute to the crystallisation peak in the DSC trace. The value of 91 J/g is based on a blend containing 30 wt % of PPSU and 70 wt % of PEEK and/or PEEK-PEDEK. Thus, the Heat of Fusion is 70%×130 J/g=91 J/g.

### EXAMPLE 5

### General Procedure for Preparing Blends

Blends were prepared by compounding on a Rondol 10 mm Twin Screw Extruder operating with a die temperature of 360° C., barrel temperature of 340° C.-360° C. and with a screw speed of 84 rpm. The polymer powders were mixed and then added to the extruder via a hopper using a ‘powder’ screw feed; polymer granules were obtained at a throughput of 196 g per hour.

### EXAMPLE 6

### General Procedure for Injection Moulding of Polymers for Fracture Toughness Testing

ASTM impact test bars were moulded on a Boy 12A injection moulding machine with a tool temperature of 220° C., barrel temperature of 360° C.-400° C. and nozzle temperature of 400° C. with a screw speed of 10 mm/s. The holding pressure was 80-95 bar.

### EXAMPLE 7

### General Procedure for Testing Fracture Toughness

Fracture toughness was measured using a 3-point bend test on an Instron 5567 tensometer with 30KN load cell according to a modified ASTM D 5045-99 test method. The test was modified such that an ASTM flex support (51 mm span) and anvil were used with a crosshead speed of 100 mm/min using a machine notched sample.

Results

Blends made using VICTREX 650G and the PEEK-PEDEK copolymer of Example 1 were tested.

Results are provided in Table 1 below.

TABLE 1

| | PEEK in | Blend composition | | Fracture | | | | |
|---|---|---|---|---|---|---|---|---|
| Example | PEEK/PEDEK | (wt %) | | Energy | Tg | Tm | X | Tc |
| No's | (mol fraction) | PEEK/PEDEK | PEEK | (KJm⁻²) | (° C.) | (° C.) | (%) | (° C.) |
| 8* | 1.00 | 0 | 100 | 15.8 | 147 | 338 | 40 | 284 |
| 9 | 0.65 | 25 | 75 | 15.9 | 151 | 333 | 34 | 278 |
| 10 | 0.65 | 50 | 50 | 17.3 | 151 | 327 | 33 | 271 |
| 11 | 0.75 | 75 | 25 | 16.5 | 155 | 315 | 36 | 251 |
| 12* | 0.90 | 100 | 0 | 15.5 | 149 | 322 | 32 | 259 |
| 13* | 0.85 | 100 | 0 | 14.3 | 150 | 314 | 29 | 248 |
| 14* | 0.80 | 100 | 0 | 15.9 | 152 | 305 | 24 | 231 |

*refers to comparative examples

The results show that the blends of Examples 9 to 11 exhibit both high fracture energy and high crystallinity. The combination of properties is improved compared to PEEK alone (Example 8) and PEEK-PEDEK alone (Examples 12 to 14). In addition, the Tm of the blends of Examples 9 to 11 is lower than the Tm of PEEK meaning the blends can be processed at lower temperatures. Additionally, the Tg of the blends is higher than for PEEK meaning the blends will advantageously retain mechanical properties at higher temperatures than for PEEK. Furthermore, the Tc of the blends is lower than for PEEK meaning that injection moulded parts can be made from the blends which have less in-built stress. This may make the blends advantageous for some applications, for example gears. In addition, the blend may be useful in production of thick-walled pipes, since such a pipe may be made with high crystallinity but with reduced built in stress (and so increased fracture toughness).

As an alternative to blends comprising only PEEK and the PEEK-PEDEK copolymer described in Example 9 to 11, blends may be made comprising the aforesaid and PPSU as described below.

### EXAMPLE 15

### Preparation of PEEK/PEEK-PEDEK/PPSU Blends

The blends were prepared by compounding VICTREX 150G, the PEEK-PEDEK copolymer of Example 2 and PPSU on a ZSK25 Twin Screw Extruder with a die temperature of 365° C., barrel temperature of 350° C.-360° C. and a screw speed of 250 rpm. The polymer powders were mixed and then added to the extruder via a hopper using a ‘powder’ screw feed, with a screw speed of 150 rpm; polymer granules were obtained at a throughput of 12 Kg per hour.

### EXAMPLE 16

### General Procedure for Injection Moulding of PEEK/PEEK-PEDEK/PPSU Blends for Fracture Toughness Testing

ASTM impact test bars were moulded on a Boy 12A injection moulding machine with a tool temperature of 195° C., barrel temperature of 360° C.-400° C. and nozzle temperature of 400° C. with a screw speed of 10 mm/s. The holding pressure was 35 bar.

Results

Characteristics of the blends of Examples 17 to 19 were assessed as described in Example 4 and results are provided in Table 2.

TABLE 2

| | PEEK in | Blend composition | | | Fracture | | | | |
|---|---|---|---|---|---|---|---|---|---|
| Example | PEEK/PEDEK | (wt %) | | | Energy | | Tm | X | Tc |
| No. | (mol fraction) | PEEK/PEDEK | PEEK | PPSU | (KJm⁻²) | Tg (° C.) | (° C.) | (%) | (° C.) |
| 17* | n/a | 0 | 70 | 30 | 1.33 | 147 | 338 | 36 | 285 |
| 18* | 0.75 | 70 | 0.00 | 30 | 2.35 | 154 | 303 | 23 | 244 |
| 19 | 0.75 | 35 | 35 | 30 | 2.22 | 148 | 328 | 31 | 272 |

*refers to comparative examples

Referring to Table 2, it will be noted that both the fracture energy and crystallinity of the PEEK/PEEK-PEDEK/PPSU blend of Example 19 are higher than for a blend of PEEK and PPSU and for a blend of PEEK-PEDEK and PPSU.

The blends described may have wide-ranging applications where high fracture toughness and high crystallinity is required.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A blend comprising:
(i) a polymeric material (A) having a repeat unit of formula
—O—Ph—O—Ph—CO—Ph— I
and a repeat unit of formula
—O—Ph—Ph—O—Ph—CO—Ph— II
wherein Ph represents a phenylene moiety; and
(ii) a polymeric material (B) having a repeat unit of formula (XX) 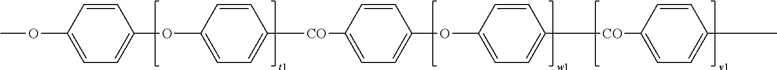
wherein t1 and w1 independently represent 0 or 1 and v1 represents 0, 1 or 2.

2. A blend according to claim 1, wherein said repeat unit of formula I has the structure 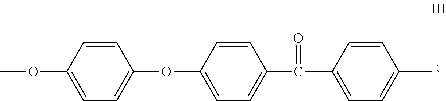
and
said repeat unit of formula II has the structure

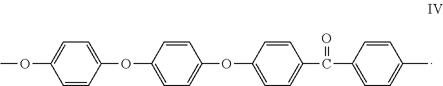

3. A blend according to claim 2, wherein said polymeric material (A) includes at least 62 mol % (e.g. at least 64 mol %) of repeat units of formula III; and at least 10 mol % (e.g. at least 18 mol %) of repeat units of formula IV.

4. A blend according to claim 2, wherein polymeric material (A) includes 58-82 mol % of units of formula III and 18-42 mol % of units of formula IV.

5. A blend according to claim 1, wherein the Tm of said polymeric material (A) is less than 330° C., for example less than 310° C.; and preferably is greater than 280° C.

6. A blend according to claim 1, wherein polymeric material (B) has a repeat unit wherein t1=1, v1=0 and w1=0.

7. A blend according to claim 1, wherein polymeric material (B) consists essentially of a repeat unit of a formula XX, preferably such a repeat unit wherein t1=1, v1=0 and w1=0.

8. A blend according to claim 1, wherein the difference between the MV of polymeric material (A) and polymeric material (B) is less than 0.3 kNsm⁻², more preferably less than 0.15 kNsm⁻², when MV is measured at 400° C. as described in Example 3.

9. A blend according to claim 1, wherein the blend comprising polymeric material (A) and polymeric material (B) has a crystallinity measured by one or both of the Example 4 method or WAXS as described of at least 30% or at least 33%.

10. A blend according to claim 1, wherein the polymeric material (A) and the polymeric material (B) define a combination (which is preferably a substantially homogenous mixture) which exhibits a single Tm and/or a single Tg.

11. A blend according to claim 1, wherein, in the blend, the difference between the Tm and Tg is in the range 155° C. to 185° C.

12. A blend according to claim 1, wherein, in the blend, the Tm is less than 330° C. and the Tg is greater than 148° C.

13. A blend according to claim 1, wherein said blend is part of a composition which includes said blend and a filler.

14. A blend according to claim 13, wherein said composition includes 50-90 wt % of said blend and 10-50 wt % of filler.

15. A blend according to claim 1, which includes a polymeric material (C) having a repeat unit of formula

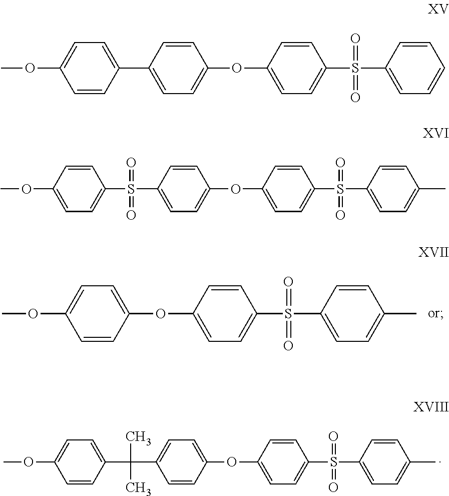

16. A blend according to claim 1, wherein the blend comprises thermoplastic polymers in the absence of filler and the blend is in the form of pellets or granules.

17. A method of improving the fracture toughness of a polymeric material (B) having a repeat unit of formula (XX) 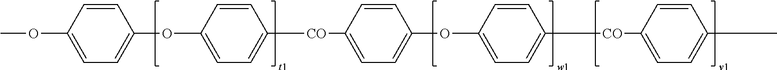
wherein t1 and w1 independently represent 0 or 1 and v1 represents 0, 1 or 2, the method comprising:
(a) selecting polymeric material (B);
(b) selecting a polymeric (A) having a repeat unit of formula
—O—Ph—O—Ph—CO—Ph— I
and a repeat unit of formula
—O—Ph—Ph—O—Ph—CO—Ph— II
wherein Ph represents a phenylene moiety; and
(c) blending polymeric material (A) with polymeric material (B).

18. A method according to claim 17, wherein said polymeric material (A) has a crystallinity of at least 15, preferably at least 27%; and said polymeric material (B) has a crystallinity of at least 30%.

19. A method according to claim 17, wherein, after step (c), the blend has a crystallinity of at least 30%.

20. A method according to claim 17, wherein polymeric material (A)
has a repeat unit of formula
—O—Ph—O—Ph—CO—Ph— I
and a repeat unit of formula
—O—Ph—Ph—O—Ph—CO—Ph— II
wherein Ph represents a phenylene moiety
and polymeric material (B) has a repeat unit of formula (XX) 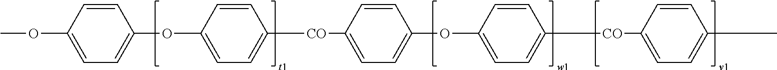
wherein t1 and w1 independently represent 0 or 1 and v1 represents 0, 1 or 2.

21. A method of making a composition which comprises:
(i) selecting a filler;
(ii) contacting the filler with a blend as described according to claim 1.

22. The use of a polymeric material (A) as described according to the first and/or second aspects for improving the fracture toughness of a polymeric material (B) as described according to claim 1.

23. A pack comprising a blend as described in claim 1.

24. A component which comprises a blend or composition according to claim 1.
